(19) United States
(12) Patent Application Publication
(10) Pub. No.: US 2016/0105028 A1
(43) Pub. Date: Apr. 14, 2016

(54) DEVICE AND METHOD FOR OPTIMIZATION OF POWER HARVESTED FROM SOLAR PANELS

(71) Applicant: Alessandro CARAGLIO, Pontedera (IT)

(72) Inventor: ALESSANDRO CARAGLIO, PONTEDERA (IT)

(21) Appl. No.: 14/894,596

(22) PCT Filed: May 28, 2014
(86) PCT No.: PCT/IB2014/061773

§ 371 Date: Nov. 30, 2015

(30) Foreign Application Priority Data
May 28, 2013 (IT) PI2013A000045

(51) Int. Cl. H02J 3/38; H02M 3/04; H02M 7/44

(52) U.S. Cl. CPC H02J 3/385; H02M 7/44; H02M 3/04; H02M 2001/0009

(57) ABSTRACT

A device for optimizing the electric power produced by direct current electric power generators, specifically photovoltaic panels, can be interposed between the generators of a string and its inverter and it includes a DC/DC conversion module suitable to implement an algorithm of MPPT, bypass means and a reactive energy compensation module. By measuring the voltage and current at input and output of the device a suitable algorithm activates and manages the above modules to extract from the panels the maximum amount of energy.

### TECHNICAL FIELD

The present invention relates to a device for the optimization of the electric power harvested from direct current electric power generators, specifically photovoltaic panels, in which the aforesaid DC generators are wired in series to form at least one string of generators connected to at least an inverter, and the aforesaid device is adapted to be installed interposed between the generators and the inverter and includes a DC/DC conversion module suitable to implement an MPPT algorithm.

The invention also relates to a method for the optimization of the electric power produced by direct current electric generators, in which the aforesaid direct current electric generators are wired in series to form at least one string of generators connected to at least an inverter.

### BACKGROUND ART

Photovoltaic installations usually include a number of photovoltaic panels connected in series to form a string. A string is connected to a string inverter, which may be a “grid-tie” inverter, that is an inverter that directly connects the photovoltaic plant to the alternating current public mains. Alternatively, a large number of strings are identical are connected in parallel with the interposition of an inverter of string or directly through a power dc bus that connects to an inverter.

The photovoltaic modules are non-linear current generators, with operating curves described by the producers, while the task of the inverter is to extract the maximum power available in continuous (DC) from photovoltaic modules by tracking a maximum power point (MPPT) and then making available the produced power into the electric grid where they are linked in the form of alternating current (AC). Since the photovoltaic modules are electric current generators connected in series (a string) in order to reach the working voltages of the inverter, if, as actually happens, the modules are not all identical, the string current will be that of the generator that provides a smaller value. This implies that, without appropriate precautions, no panel, and in the best case only one, works at its maximum power point.

The factors that can adversely affect and differentiate the behaviour of the photovoltaic panels are many and, excluding design or installation errors that need to be fixed upstream, such factors can be categorized as a function of the impact that they have on the power produced by the photovoltaic panel. You can then identify three main categories of issues that affect the power produced by a photovoltaic panel:
a)—very important shadows or other relevant criticality that reduces by more than 50% the power produced by the panel in respect to the nominal power,
b)—quite important shadows, high mismatching, or other criticality that reduces the power between 5% and 50%,
c)—tolerances due to aging, light shading, dirt, ice, different temperatures between the panels and other critical factors that reduce the power of less than 5%.

The problems of the category (a) are conventionally solved using bypass diodes inserted into a junction box at the output of the panel.

These prevent the reverse bias of cells and thus their early aging. However, in the diodes themselves occurs a certain power dissipation, which is subtracted from that produced by the other panels of the string. In addition, the heat dissipated by the diodes leads to inhomogeneity of temperature of the cells and thus loss of power production.

It is therefore important to carry out the bypass in a way that is the less energetically and economically burdensome as possible. Circuit topologies are known which are based on MOSFETs that can be used to simulate the behaviour of diodes with a lower dissipation, however they significantly increase the cost of the circuit.

When the loss of power is lower and comes substantially in category (b), the problem can be solved not by excluding the panel from the string but by using optimization techniques.

A known optimization technique provides for the use of DC/AC micro-inverters equipped with MPPT, namely the use of an inverter associated with a reduced number of panels, typically from 1 to 4. This allows a more accurate harvesting of power from the panels, but it has greater costs and power losses in the conversion of power for the electric mains.

A different optimization technique consists of associating to each panel an optimization device, by interposing it between the panel and the (string) inverter. This device performs a DC/DC conversion, buck and/or boost type, based on an MPPT algorithm. Devices of this type are described, for example in U.S.2009150005 and in EP2533299. However, the optimization with devices capable of performing a distributed MPPT by means of a DC/DC conversion is advantageous only when the loss of power is within the above mentioned b) class. When the system does not have particular problems and the loss of power falls into class c) each DC/DC converter unnecessarily dissipates energy, in many cases more than the one that it allows to retrieve so that it results in a worse efficiency of the plant.

Another type of device is described in U.S.2010028832, which is capable to perform an optimization of the energy produced, thanks to the presence of a DC/DC converter with MPPT algorithm, and it is also capable to protect the panel to which it is associated from string overvoltage. Nevertheless, even this type of device is affected by the limitations described above because it does not allow to harvest all of the energy produced by the panels in conditions that fall under the above mentioned class c), that is to say where the criticality causes a reduction lower than 5% of the electric power produced by the panel.

### DISCLOSURE OF INVENTION

### Technical Problem

Object of the present invention it is therefore to provide a device and method for optimization of the electric power produced by direct current electric power generators, specifically photovoltaic panels, able to effectively retrieve even the power lost due to factors of lesser impact such tolerance by aging, light shading, dirt, ice, different temperatures between the modules.

A further object of the present invention is to provide an apparatus comprising a MPPT module with DC/DC converter and a MPPT method with optimized efficiency.

Another object of the present invention is to provide a device which can be associated with photovoltaic modules, the device being provided with bypass module having optimized efficiency.

Another object of the present invention is to provide a device which can be associated with photovoltaic modules that allow us to act with high safety in the event of a fire in the plant, or in the surrounding areas even when there is the need to switch off the electric wires, for example for maintenance.

### Technical Solution

According to one aspect of the present invention, the above objects are achieved thanks to a device for the optimization of the energy produced by direct current electric power generators connected in series to form at least one string of generators connected to at least an inverter, said device comprising:
at least one input module comprising input bypass means suitable for shorting said generator disconnecting it from the rest of the string and preventing the reverse bias;
at least one reactive energy compensation module comprising at least one component with adjustable reactance;
at least one DC/DC conversion module with switching technology adapted to implement an algorithm of maximum power point tracking;
bypass means associated to each DC/DC conversion module for bypassing the DC/DC conversion module thereof;
input voltage and/or current measuring means and output voltage and/or current measuring means of the said device;
a control unit adapted to control the above mentioned modules and bypass means at least as a function of the input and output current and/or voltage to optimize the power output of the system.

The device outlined above allows the optimization of the energy produced by the photovoltaic system by implementing both conventional techniques such as the maximum power point tracking and an innovative technique consisting in the compensation of reactive energy.

The device advantageously provides an output module comprising output bypass means suitable for exclude the generator and said DC/DC conversion module associated with it from the rest of the string, so as to eliminate the dissipation of energy that would occur in the DC/DC conversion module in the event of bypass of the panel.

Preferably, the device comprises:
at least two input modules, each of which is connected to a generator;
a reactive energy compensation module for each generator connected to said device;
a DC/DC conversion module for each generator connected to said device, operating with buck type switching technology;
bypass means of each DC/DC conversion module;
output decoupling means suitable to receive in input said two DC/DC conversion modules and to return a single output voltage as an output.

The above embodiment of the device allows to reduce the number of devices to be installed in the string for a same number of generators and it also halves the incidence of inaccuracy of voltage and current measurements.

Advantageously, both the DC/DC conversion modules and the bypass means thereof each comprise at least one switch which is connected in series to its generator so that the simultaneous opening of said switches separates the generators associated with said device from the rest of the system.

The controller can then open the above switches, so that the panels are separated from the string and it allows, for example in case of fire, to set to zero the voltage and current at the output of the device, leaving at the input of the device just the voltage of the panels (a few volts), thus allowing the use of extinguishing foams.

According to another aspect of the present invention, the aforesaid objects are achieved by means of a method for the optimization of the energy produced by direct current electric power generators connected in series to form at least one string of generators connected to at least an inverter, and wherein optimization devices are arranged between each of said generators and said inverter and include:
at least one input module comprising input bypass means suitable for shorting said generator disconnecting it from the rest of the string and preventing the reverse bias;
at least one reactive energy compensation module comprising at least one component with adjustable reactance;
at least one DC/DC conversion module with switching technology adapted to implement an algorithm of maximum power point tracking;
bypass means associated to each DC/DC conversion module for bypassing the DC/DC conversion module thereof;
input voltage and/or current measuring means and output voltage and/or current measuring means of the said device;
   and wherein,as a function of the detection of the input and output voltages and/or current it is defined a conditioning procedure of the power produced by the photovoltaic panels associated with the device by choosing this conditioning procedure among:
the bypass of the panel by operating the input bypass means,
the compensation of reactive energy by activating and driving the reactive energy compensation module,
the activation of a MPPT algorithm implemented via the DC/DC conversion module with buck type switching technology,
a combination of the above techniques.

The method of the invention makes it possible to optimize the energy produced, choosing continuously and dynamically the most suitable optimization technique among those available. In particular, the method of the invention allows the use of a reactive energy compensation technique when the maximum power point tracking technique is not effective, i.e. when the differences of power produced by the various panels are minimal because it is only due to minor factors such as aging, light shading, dirt, areas at a different temperature, etc.

### DESCRIPTION OF THE DRAWINGS

These and other features of the invention will become more readily apparent from the following description of preferred embodiments of the invention, given as non-limiting examples, with reference to the accompanying drawings in which:

FIG. 1 shows a schematic representation of a string of a photovoltaic system that includes a plurality of devices according to a first embodiment of the invention;

FIG. 2 shows a schematic representation of a string of a photovoltaic system that includes a plurality of devices according to a second embodiment of the invention;

FIG. 3 shows a functional block diagram of a device according to the embodiment of FIG. 1 associated with a respective generator;

FIG. 4 shows a functional block diagram of a device according to the embodiment of FIG. 2 associated with two respective generators;

FIG. 5 shows a diagram of greater detail of a specific embodiment of the apparatus shown in FIG. 4.

FIG. 6 shows a flow chart of some of the steps of a method according to the invention;

FIG. 7 shows a flowchart of further steps of a method according to the invention.

### DESCRIPTION OF PREFERRED EMBODIMENTS

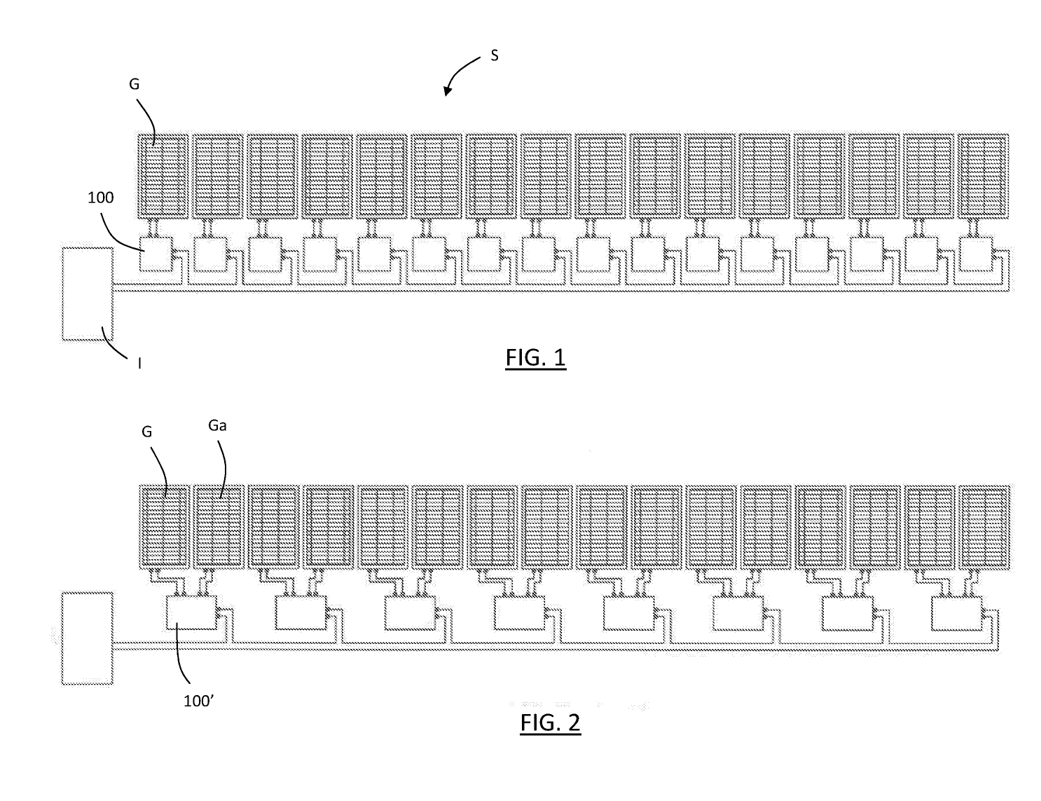

With reference to FIG. 1 is indicated as a whole with S a string of a photovoltaic system comprising a plurality of photovoltaic modules, G. Every photovoltaic module is associated with a device, 100, according to the present invention and the above mentioned devices are connected in series with each other and to a string inverter, I. The layout of the photovoltaic system could provide for the presence of additional strings and a centralized inverter in addition to or in replacement of the string inverter I.

According to a preferred embodiment of the invention, shown in FIG. 2, to each device, 100′, are associated two generators G, Ga, of the string S.

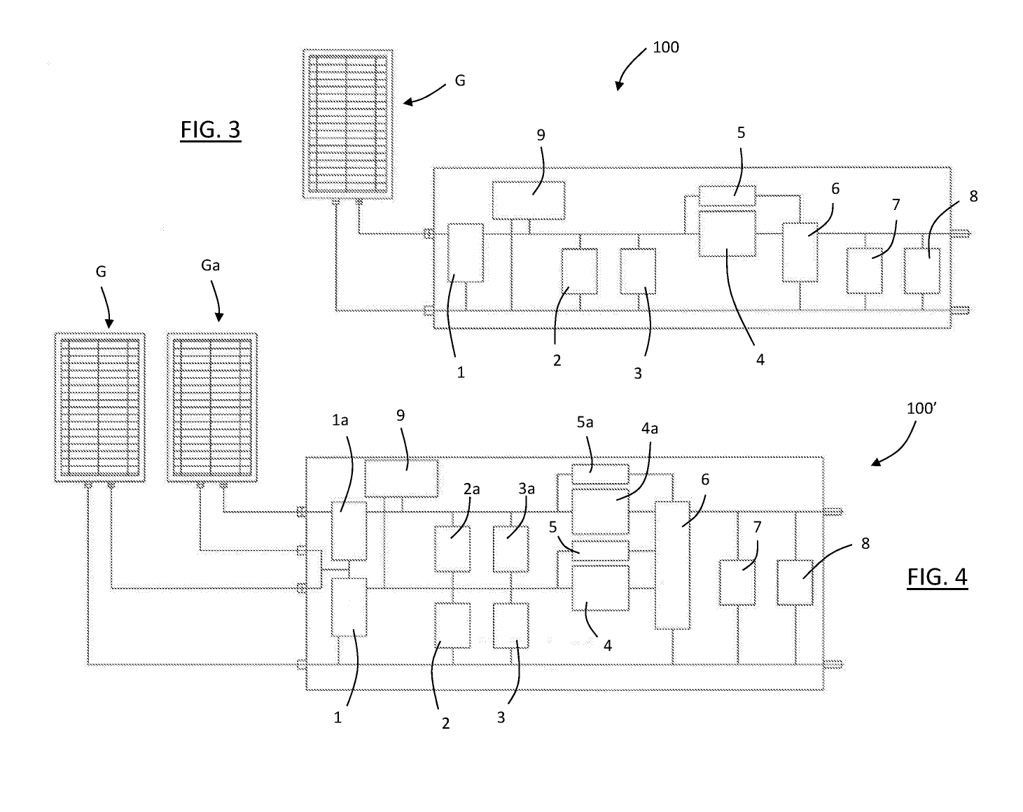

With reference to FIG. 3, a device 100 according to the first embodiment includes:
input voltage and/or current measuring means, 1;
an input module 2, comprising input bypass means suitable to short out the generator G associated with the device so as to disconnect it from the rest of the string S and preventing its reverse bias;
a reactive energy compensation module, 3, comprising at least one component with adjustable reactance;
a DC/DC conversion module, 4, operating with switching technology and adapted to implement an algorithm for the maximum power point tracking (MPPT);
MPPT bypass means, 5, arranged in parallel to the above DC/DC conversion module 4 to enable the bypass;
a noise filtering module, 6, suitable to filter the noise due to the switching that takes place in the DC/DC conversion module,
an output module, 7, comprising output bypass means adapted to exclude the device 100 and the generator G associated with it from the rest of the string S;
output voltage and/or current measuring means, 8; and
a control unit, 9 adapted to controlling the above modules 2, 3, 4, 7 and bypass means 5 as a function of at least the input and output current and/or voltage to optimize the power output of the panel G.

In the preferred embodiment of the invention, in which each device 100′ is associated with two generators G, Ga, there are, with reference to FIG. 4, input voltage and/or current measuring means 1, an input module 2 comprising bypass means, a reactive energy compensation module 3, a DC/DC conversion module 4 and relative bypass means 5, associated with the first generator G, and further similar components 1a, 2a, 3a, 4a, 5a associated with the second generator Ga. In the noise filtering module 6 the circuits are coupled so as to have a single output voltage from the device and also the output components, i.e. , the output bypass means module 7 and the output voltage and/or current measuring means 8, are single.

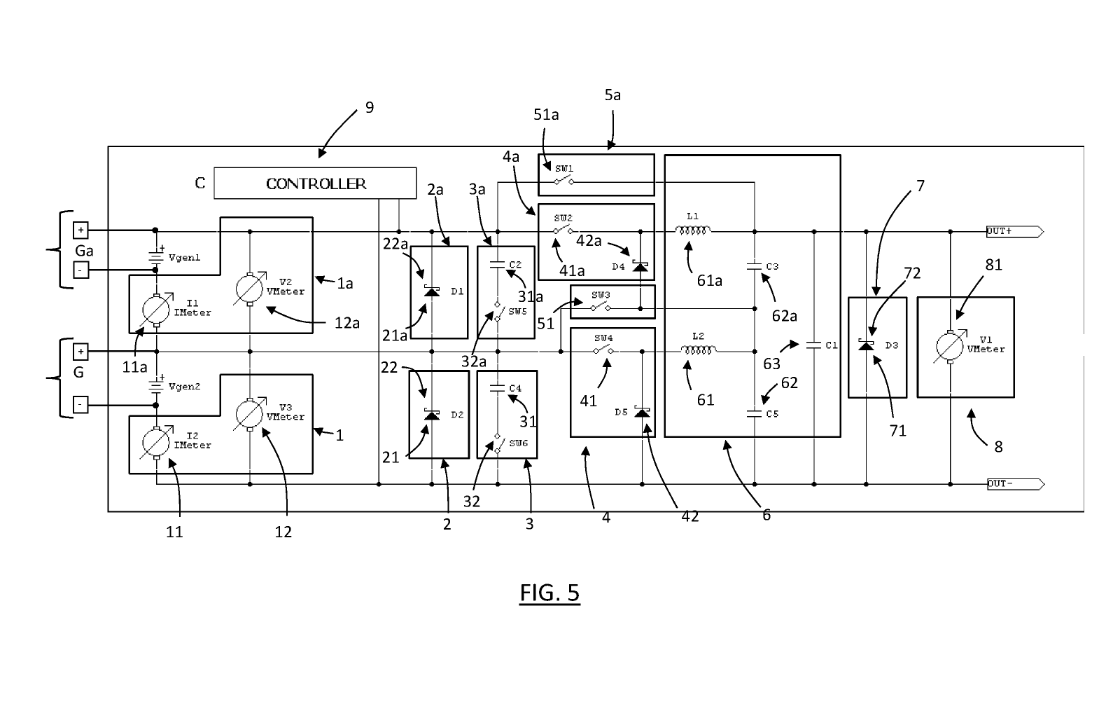

With reference to FIG. 5 will now be described in more detail, this second preferred embodiment.

Advantageously, the input voltage and/or current measuring means 1 comprises a means for measuring input current, 11, 11a, and means for measuring the input voltage, 12, 12a. The measurement system can be realized in a variety of ways. Typically, the acquisition of the voltage value is effected by means of a resistive divider followed by a buffer with a high impedance input, so as to be able to minimize losses. The resistive divider is part of the anti-aliasing input filter, so as to maximize immunity to external noise, particularly due to the type of load, i.e. the inverter I. The acquisition of the current value is advantageously realized by means of a resistive or Hall effect current/voltage converter. If the measurement is made low-side many advantages are obtained from the point of view of the CMRR (Common Mode Rejection Ratio) required for the conversion stage. Of course, it is possible to use many alternatives of known technologies for the measurement of current that can be selected by trying to reach a balance between cost and performance.

The bypass means of the input module 2 preferably consist of two distinct electronic components: a field effect transistor, 21, 21a, and a high performance diode, 22, 22a (even if in FIG. 5 shown with a single diode symbol). In conditions of relatively low current it is used the field effect transistor 21, 21a, where the channel has a resistive value and the dissipation is minimal, whereas in the condition of high current the diode 22, 22a is used. The association of the two components, used selectively in specific conditions, allows considerable advantages in terms of power dissipation, without having to use greatly oversized field-effect transistors.

The reactive energy compensation module 3 comprises one or more capacitive components, 31, 31a, connected in parallel to the generator G, Ga respectively by means of one or more respective electronic switches 32, 32a. The electronic switches need to be able to let the capacitive elements charge and let them discharge when not controlled. Each electronic switch 32, 32a, advantageously consists of a field effect transistor and by a freewheeling diode and these two components are sized for the charging current of the capacitive elements in the most critical condition and they are able to work at the switching frequency set by controller 9. The reactance (capacitive) generated in the reactive energy compensation module 3, 3a is adjusted by the controller 9 as a function of the duty-cycle that it sets and the working frequency of the load connected at the output, i.e. the inverter I. In the controller 9 it is carried out an appropriate algorithm that defines the value to which the reactance generated by the reactive energy compensation module 3, 3a must be set in order to maximize the power extracted from the panel G, Ga. The principle according to which the reactive energy compensation module 3, 3a is capable of retrieving energy from the panel is based on the fact that the MPPT algorithm of the inverter is an electronics based on controlled current pulses (switching), then, though the upstream section of it, i.e. the generators G connected in series, is largely regarded as a direct current (DC) circuit, it also contains a significant amount of alternating current at the operating frequency of the MPPT inverter I. The use of reactive components makes a sort of partial bypass that, when the user work point changes, allows the system to store in the capacitive components 31, 31a energy that would normally be lost, such energy being then returned to the string (S).

In a different embodiment of the device of the invention a reactive energy compensation module 3, 3a, can be achieved by providing inductive type adjustable reactances, connected in series to the generator, with the relative electronic switch connected in parallel.

The DC/DC conversion module 4, 4a, is formed by switches, 41, 41a, connected in series to the respective generator G, Ga, and by additional switches, 42, 42a, having the function of freewheeling diode. The latter can be synchronized with the respective switches 41, 41a.

The noise filtering module 6 comprises one or more inductors 61, 61a associated in series to each generator G, Ga, one or more capacitive elements 62, 62 associated to each of the generators G, Ga and one or more decoupling capacitive elements, 63, at the outlet. Then, in the present embodiment of the device, the noise filtering module realizes decoupling means with which two DC/DC conversion modules 4 and 4a, are associated in input, providing then a single voltage output. The noise filtering module 6 has the function of eliminating from the spectrum of the output voltage the frequency range which is around the switching frequency. The decoupling capacitive elements realize a RC filter (RLC) through the wiring of the photovoltaic system and any input filters of the inverter I. This allows a further reducction of noise coming from a DC/DC conversion stage of the inverter I itself. In addition, the decoupling capacitive elements 63, being reactive components in pulsed direct current, and then being capacitive reactances, compensate at least partially the inductive reactance mainly due to the wiring of the photovoltaic system.

Each DC/DC conversion module 4, 4a, together with the relative inductance 61, 61a of the noise filtering module 6, and together even to a system for driving the switches and a suitable algorithm for maximum power point tracking, form a MPPT module.

The bypass means 5, 5a of the DC/DC conversion module include a bypass switch, 51, 51a, and they allow, when needed, to connect the output directly to the input, to exclude the DC/DC conversion module 4, 4a so limiting the power dissipation, as they create for the current an alternate route to the inductance 61, 61a.

The output module 7 comprises output bypass means preferably formed the same as the bypass means of the input module 2. More specifically, they preferably consist of two distinct electronic components: a field effect transistor, 71, and a high performance diode, 72. The output bypass means enable the correct operation of the MPPT modules. In the case that the bypass means of the input modules 2, 2a, are driven in bypass, also the bypass means of the output module are driven in bypass, thus providing a preferential path and preventing the dissipation of energy in the upstream modules.

The output voltage and/or current measuring means 8 can be made with the same components and circuit type as the input means 1, or they can be differently realized. In a preferred embodiment, the output measuring means 8 include only means for measuring the output voltage 81.

The controller 8 includes, not shown in the figures, at least a logic control unit preferably consisting of an MCU (micro controller unit), a CPLD (Complex Programmable Logic Device) or a Field Programmable Gate Array (FPGA), one or more switching type power suppliers for supplying the microcontroller, power stages suitable for driving the electronic components of the devices, one or more switching power suppliers for the supply of said power stages. More specifically there are power stages for the control of the bypass means of the input modules 2, 2a and the output module 7, power stages to control the reactive energy compensation modules 3, 3a, and power stages to control the DC/DC conversion modules 4, 4a and the associated bypass means 5, 5a.

The controller 8 also comprises at least a temperature sensor, which is not shown, that allows it to take effective measures in case of detection of operation parameters out of specifications. In fact, conventionally, in the event of a fire it is not possible to intervene on the panels and on the string with extinguishing foams due to the high string voltage (500-700 Volts). In the device of the present invention the switches 41, 51, 41a, 51a, can be opened all at the same time to separate the string from the panels and thus be able to intervene on the latter with extinguishing foams. The command to open the above switches may be by the control logic of the controller 8 as a result of the information received by the temperature sensor or, still driven by the controller 8, it can be controlled from the outside through an emergency button or a remote control that cut the power supply to the controller 8.

The above described device is advantageously used according to the method of the present invention to optimize the energy production of photovoltaic installations, and in particular of a string of generators.

The method of the present invention provides that, on the basis of the detection of the voltages and/or current at the input and output from the device. it is defined an optimisation mode of the power produced by photovoltaic panels associated with the device by selecting the optimization mode among:
the bypass of the panel by input bypass means 2, 2a,
the reactive compensation via activation and driving the reactive energy compensation module 3, 3a,
the activation of an MPPT algorithm implemented via a buck type DC/DC conversion module 4, 4a,
a combination of the above techniques.

The method outlined above is implemented through the implementation, in the controller 8, of a control algorithm that provides a main coordination procedure and five subsections: an initialization procedure, a procedure for detecting the present condition, a procedure for the management of the reactive energy compensation modules 3, 3a, a procedure for managing the MPPT modules and in particular the DC/DC conversion modules 4, 4a, a procedure for the management of input 2, 2a, and output 7 modules, and in particular of their bypass means.

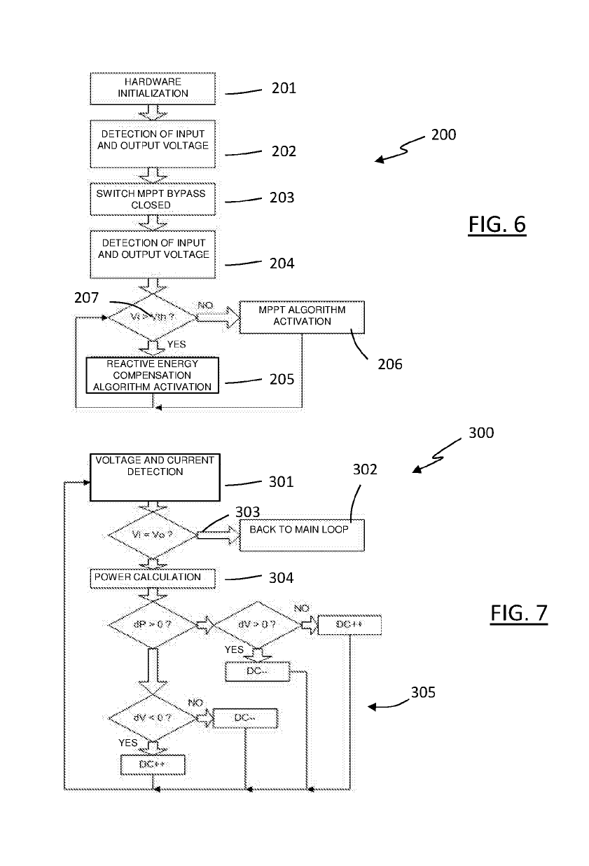

With reference to FIG. 6 the main coordination procedure, 200, provides for, at startup, the execution of the initialization procedure, 201, where the hardware is activated and it is checked for proper working. The initialisation is followed by detection of the voltages and/or current at the input and output, 202. In a preferred embodiment of the method only the input, Vi, and output, Vo voltages are detected. As a result of certain conditions of the voltages at the input and output the bypass means of the input 2, 2a, and output 7 modules are activated. After the first detection of voltages 201 the bypass means 5, 5a of the DC/DC conversion stages 4, 4a, are activated by closing the corresponding switches, step 203, then a new detection of input and output voltages, 204 is performed. On the basis of the results of the new detection the activation, 205, of the procedure for the management of reactive energy compensation modules 3, 3a, occurs, otherwise the activation, 206 of the procedure of management of MPPT modules takes place. More specifically, the input voltage Vi is compared with a threshold voltage, Vth, 207, and if it is greater than the latter the procedure for the management of reactive energy compensation modules 3, 3a, is activated, otherwise it is turned on the procedure of management of MPPT modules, with obviously disabling the bypass means 5, 5a.

Referring to FIG. 7, the procedure for the management of a MPPT module, 300, provides for the detection of the input voltage Vi and the input current, li, step 301. By using the detected data the existence of a condition of exiting from the procedure, 302, is verified in particular by checking whether the input voltage Vi is equal to the output voltage Vo, 303. If the input voltage is equal, within a range, to the output voltage Vo, the implementation of the management procedure MPPT is not necessary because this optimization technique is not to be taken. Although a check of the voltages is made to enter the procedure, a similar check must also be made to define the exit condition and to avoid live-lock. Then the input power P, 304 is calculated. Then, step 305, the calculated power P and the input voltage Vi are compared with respective calculated values which have been measured and stored in a previous cycle of the procedure 300 and on the basis of these comparisons the mode of driving the buck type DC/DC conversion modules 4, 4a is defined. The cycle is repeated until the occurrence of the exit condition.

A similar algorithm is executed in the procedure for managing the reactive energy compensation module 3, 3a by providing different thresholds and ranges.

A proper definition of the thresholds and the ranges both in the main coordination procedure and in the subsections also allows the simultaneous implementation of the various optimization techniques described above.

The presence of at least two generators G, Ga, associated with the same device 100 allows to simplify the definition of the thresholds since the incidence of measurement errors halves. Nevertheless, the above layout also has clear economic benefits due to a reduction in the number of devices 100 needed once fixed the number of generators G per string.

Certainly the benefits of the device and method of the invention remain unchanged even in presence of changes or variations with respect to what is described.

For example, in a method according to the invention the maximum power point tracking function which is implemented in the management procedure of MPPT modules can also be made by measuring only the voltages. In addition, these functions could also be performed with the aid and the interaction of a centralized external processor able to coordinate the operation of a plurality of devices 100 according to the invention.

Further modifications and variations may concern the electronic components used which will be advantageously components that ensure high efficiency and limited losses such as capacitors low-ESR, inductors with low RS, etc.

These and other modifications can be made to the device and method of the invention without departing from the scope of protection as defined by the following claims.

1-14. (canceled)

15. A device for the optimization of power produced by direct current electric power generators connected in series to form at least one string of generators connected to at least an inverter, wherein the device is of the type that is interposed between the generators and the inverter and includes a DC/DC conversion module suitable to implement a maximum power point tracking algorithm, comprising:
at least one input module comprising a bypass device suitable for shorting the generator and disconnecting it from a remaining portion of the string and preventing a reverse bias;
at least one reactive energy compensation module comprising at least one component with adjustable reactance;
at least one DC/DC conversion module with switching technology adapted to implement an algorithm of maximum power point tracking;
a bypass device associated with each DC/DC conversion module for bypassing the DC/DC conversion module thereof;
an input voltage or current measuring device and output voltage or current measuring device; and
a control unit adapted to control the input, reactive energy compensation or DC/DC conversion modules and the bypass device as a function of the input and output current or voltage to optimize a power output of the string;
wherein the reactance generated in the reactive energy compensation module is adjusted by the control unit as a function of a duty-cycle that the control unit sets and a working frequency of a load connected at an output of the device.

16. The device according to the claim 15, wherein the control unit performs an algorithm that defines a value to which the reactance generated by the reactive energy compensation module must be set in order to maximize the power extracted from a panel.

17. The device according to claim 15, further comprising an output module comprising an output bypass device operable to exclude the generator and the DC/DC conversion module associated with it from the remaining portion of the string.

18. The device according to claim 15, wherein the component with adjustable reactance comprises at least one capacitive component and at least one electronic switch connected in parallel to the generator thereof.

19. The device according to claim 15, wherein the component with adjustable reactance comprises at least one inductor connected in series to the generator thereof and at least one electronic switch connected in parallel to the generator thereof.

20. The device according to claim 15, further comprising:
at least two of the input modules to each of which is connected a generator;
a reactive energy compensation module for each generator connected to the device;
a DC/DC conversion module for each generator connected to the device, operating with a buck type switching technology;
a bypass device of each of the DC/DC conversion modules; and
an output decoupling device operable to receive in input the two DC/DC conversion modules and to return as an output, a single output voltage.

21. The device according to claim 15, wherein the control unit comprises a programmable logic control, one or more switching type power supply devices for the power supply of the logic control, power stages operable for driving the electronic components of the device, and one or more switching type power supply devices for the power supply of the power stages.

22. The device according to claim 15, wherein each of the input and output bypass devices comprises at least one diode and at least one transistor.

23. The device according to claim 15, wherein each of the DC/DC conversion modules and the bypass devices comprises at least one switch connected in series to a corresponding generator so that when all the switches are simultaneously open, the generators associated with the device are separated from the remaining portion of the string.

24. A method for the optimization of power produced by direct current electric power generators connected in series to form at least one string of generators connected to at least one inverter, wherein optimisation devices are interposed between each of the generators and the inverter, comprising the steps of:
providing at least one input module comprising an input bypass device suitable for shorting the generator and disconnecting it from a remaining portion of the string and preventing a reverse bias;
providing at least one reactive energy compensation module comprising at least one component with adjustable reactance, wherein the reactance generated in the reactive energy compensation module is adjusted by a control unit as a function of a duty-cycle that the control unit sets and the working frequency of a load connected at an output of the device;
providing at least one DC/DC conversion module with switching technology adapted to implement an algorithm of maximum power point tracking;
providing a bypass device associated with each of the DC/DC conversion modules for bypassing the DC/DC conversion module thereof; and
providing an input voltage or current measuring device and output voltage or current measuring device;
wherein, as a function of detection of the input and output voltages or current, an optimisation mode of the power produced by the generators associated with the device is performed by selecting the optimisation mode among any of:
bypassing the generator by controlling the input bypass device;
performing reactive compensation by driving the reactive energy compensation module; and
activating, through a switching technology, a maximum power point tracking algorithm implemented via the DC/DC conversion module.

25. The method according to claim 24, wherein, when specific input and output voltage or current values are determined, the DC/DC conversion modules are bypassed by the bypass device thereof, and the power produced by the generators is conditioned by controlling the reactive energy compensation module.

26. The method according to claim 24, wherein the reactive energy compensation module is controlled by adjusting a value of a relative reactance as a function of the input and output voltage or current values.
